(19) United States
(12) Patent Application Publication
(10) Pub. No.: US 2011/0088274 A1
(43) Pub. Date: Apr. 21, 2011

(54) JIG FOR POSITIONING FURRING RAILS

(76) Inventor: Kevin Lonergan, Kilmacthomas (IE)

(21) Appl. No.: 12/906,458

(22) Filed: Oct. 18, 2010

(30) Foreign Application Priority Data
Oct. 21, 2009 (IE) S2009/819

(51) Int. Cl. G01D 21/00; E04F 21/18

(52) U.S. Cl. 33/613

(57) ABSTRACT

A jig for use in positioning steel furring rails in a suspended ceiling construction is disclosed. The jig comprise an arm having at each end a receptacle for receiving a respective furring rail transversely of the arm. A first of the receptacles has an inwardly extending member on its outer edge for supporting the weight of that end of the jig by hooking the member around the edge of a furring rail proximate the first receptacle. The second receptacle has a magnet for supporting the weight of that end of the jig by magnetic attraction to a furring rail in the second receptacle.

### CROSS-REFERENCE TO RELATED APPLICATIONS

This application claims priority to Irish patent application Serial No. S2009/819 filed on Oct. 21, 2009 by the same inventor and bearing the same title as the present application. The complete disclosure of the Irish application is hereby incorporated herein by reference.

### BACKGROUND OF THE INVENTION

This invention relates to a jig for use in positioning steel furring rails in a suspended ceiling construction.

FIG. 1 is a partially cutaway diagram of a typical suspended ceiling construction. Steel perimeter channel 10 having a generally C-cross section is fixed horizontally around the walls of the room in which the suspended ceiling is to be constructed. Steel furring rails 12 extend parallel to one another horizontally between opposite perimeter channels 10 (the furring rails 12 are also known as “hat channels” due to their cross-sectional shape, i.e. a pair of outwardly extending flanges on opposite sides of a trapezoid channel). The ends of the rails 12 are slidable along the perimeter channels 10, but adjacent rails 12 are held a specific distance apart, e.g. 16 inches, by fixing them using clips 18 to horizontal steel primary channels 14 which are suspended by rigid hangers 16 from the floor 19 above. Finally, plasterboard panels 20 are fixed to the underside of the furring rails 12 and a layer 21 of fibreglass insulation may be laid over the plasterboard and rails 12.

### SUMMARY OF THE INVENTION

It is an object of the invention to provide a jig which will assist a fitter in accurately positioning each furring rail at the correct distance from its neighbour prior to fixing it to the primary channels and/or the perimeter channels.

According to one aspect of the present invention, there is provided a jig for use in positioning steel furring rails in a suspended ceiling construction, the jig comprising an arm having at each end a receptacle for receiving a respective furring rail transversely of the arm, a first of the receptacles having an inwardly extending member on its outer edge for supporting the weight of that end of the jig by hooking the member around the edge of a furring rail proximate the first receptacle, and the second receptacle having a magnet for supporting the weight of that end of the jig by magnetic attraction to a furring rail in the second receptacle.

Preferably the arm is adjustable in length, most preferably telescopically.

According to a second aspect there is provided a jig for use in positioning steel furring rails during building construction, the jig comprising an arm having at each end a receptacle for receiving a respective furring rail transversely of the arm, a first of the receptacles having a magnet for supporting that end of the jig by magnetic attraction to a furring rail in the first receptacle, and the second receptacle having a magnet for supporting that end of the jig by magnetic attraction to a furring rail in the second receptacle.

Embodiments of the invention will now be described, by way of example, with reference to the accompanying drawings, in which:

### BRIEF DESCRIPTION OF THE DRAWINGS

FIG. 1 (previously described) is a partially cutaway diagram of a typical suspended ceiling construction.

FIG. 2 is a perspective view of a jig for use in constructing the ceiling shown in FIG. 1, the two telescopically connected parts being shown separated.

FIG. 3 is a side view of the jig.

FIGS. 4A and 4B illustrate how the jig is used.

FIGS. 5A and 5B show perspective and cross-sectional views respectively of an alternative embodiment of the invention.

### DETAILED DESCRIPTION OF THE EMBODIMENTS

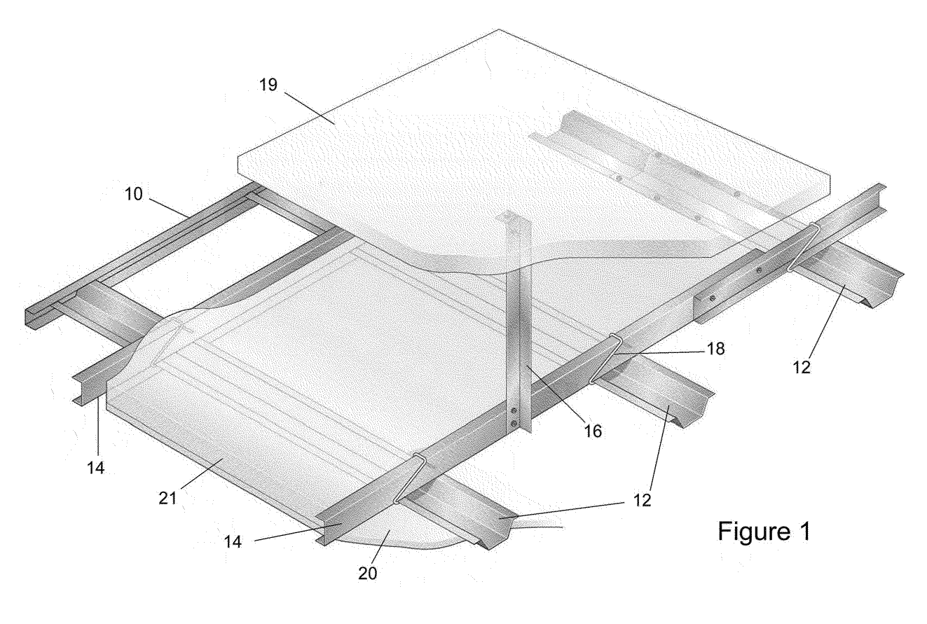

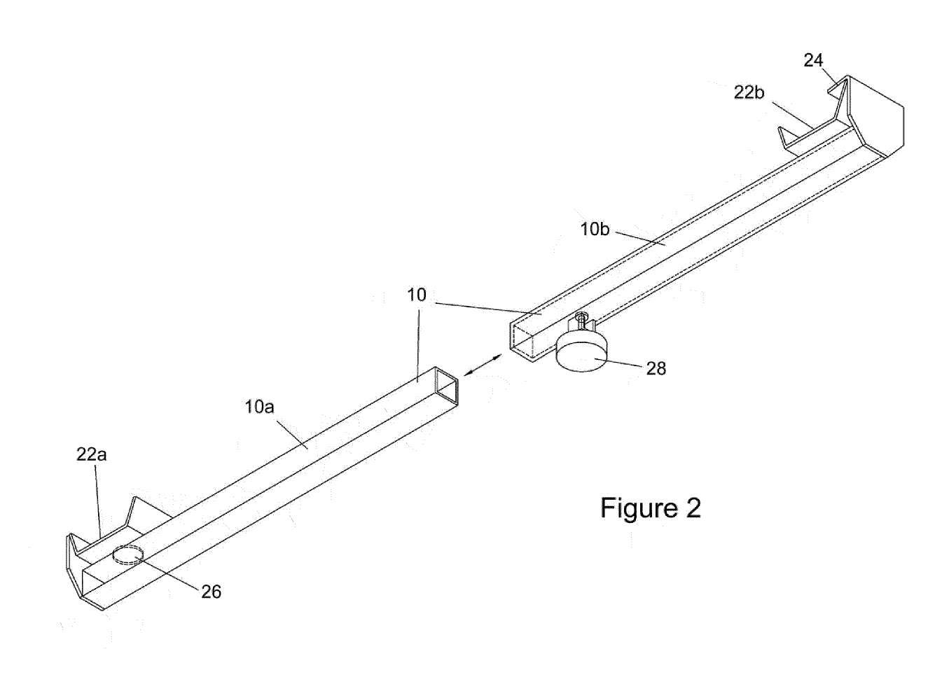

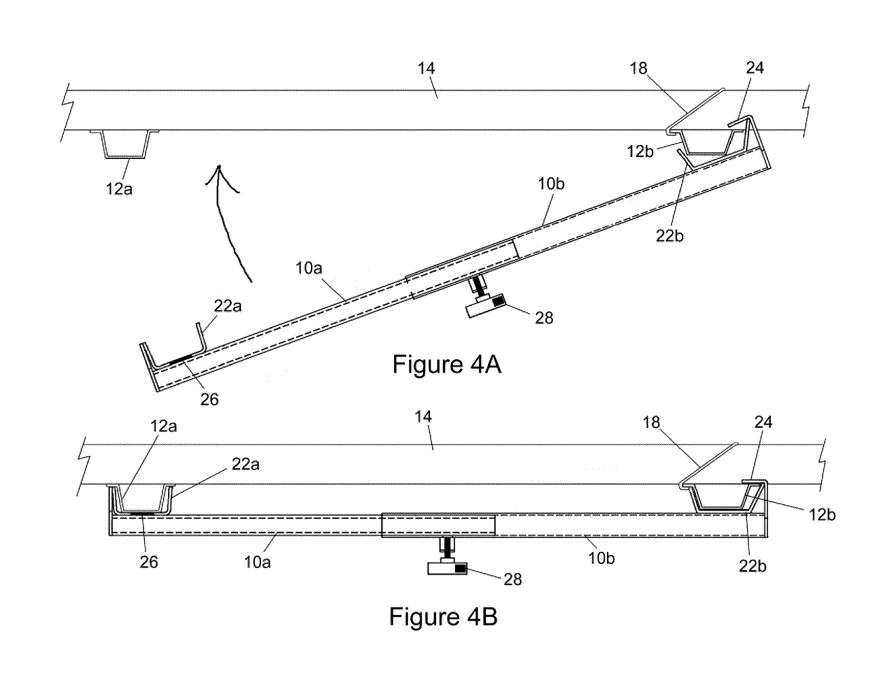

FIGS. 1 to 3 show a jig for use in positioning steel hat channel furring rails 12 in a suspended ceiling construction. The construction and operation of the jig will be explained with reference to FIGS. 4A and 4B which show a pair of furring rails 12a, 12b extending transversely below a parallel set of primary channels 14, of which only one such channel is seen in the side view of FIGS. 4A and 4B. The rail 12b is already clipped in its final position to the primary channels 14, and the jig is used to position the rail 12a, which is resting loosely on the perimeter channels 10, a specified distance from the rail 12b for subsequent clipping of the rail 12a to the primary channels 14 and/or fixing to the perimeter channels 10.

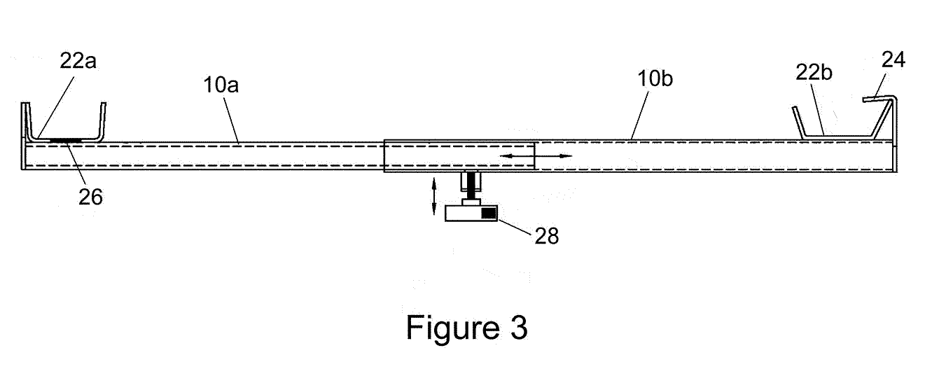

The jig comprises an arm 10 comprising two hollow axially aligned steel sections 10a and 10b. It will nonetheless be appreciated that the sections could be fabricated from any suitable material. Each section 10a, 10b has a rectangular cross section, the section 10a having cross-sectional dimensions slightly smaller than the section 10b to allow the sections to be telescopically connected (FIG. 3).

The free end of each section 10a, 10b has a respective receptacle 22a, 22b for receiving a respective furring rail 12a, 12b extending transversely of the arm 10, FIG. 4B. The receptacle 22b has an inwardly extending flange 24 on its outer edge for supporting the weight of that end of the jig by hooking the flange 24 around the edge of the furring rail 12b, see the right hand end of FIG. 4A, and the receptacle 22a has a permanent magnet 26 for supporting the weight of that end of the jig by magnetic attraction to the furring rail 12a, see the left hand end of FIG. 4B.

The overall length of the arm 10 is adjustable telescopically so that the distance between the two receptacles 22a, 22b is the same as the desired distance between the furring rails 12a, 12b. The selected length is maintained by tightening the screw 28.

In use, FIG. 4B, the receptacle 22b is hooked on to the outer edge of the furring rail 12b using the flange 24. This is done near one end of the rail 12b, where it engages a perimeter channel 10. Then the other end of the jig is swung up until the furring rail 12a enters the receptacle 22a, the position of the furring rail along the perimeter channel 10 being adjusted if necessary. The jig can now be released since the weight of the end of the jig having the receptacle 22a is supported by magnetic attraction between the magnet 26 and the furring rail 12a.

The jig can now be left in position on the rails 12a and 12b and the fitter moves to the other end of the rail 12b, where it engages the opposite perimeter channel 10. The same process is carried out using a second jig at the other end of the rails 12a, 12b. The rail 12a is now accurately positioned relative to the rail 12b at both ends, and hence along its entire length, and leaving both jigs in place the rail 12a can be clipped to the primary channels 14 and/or fixed to the perimeter channel 10.

If desired, the receptacle 22b with the flange 24 could be hooked on the furring rail 12a and the other end of the jig swung up to engage the furring rail 12b.

It will also be seen that the flange 24 for receptacle 22b enables the jig to be left hanging on a furring rail 12a while the next furring rail 12b is being located in perimeter channel 10 and then swung into location when required.

It will be seen that indicia (not shown) can be provided on the arm 10 to assist in adjusting the arm to the required length.

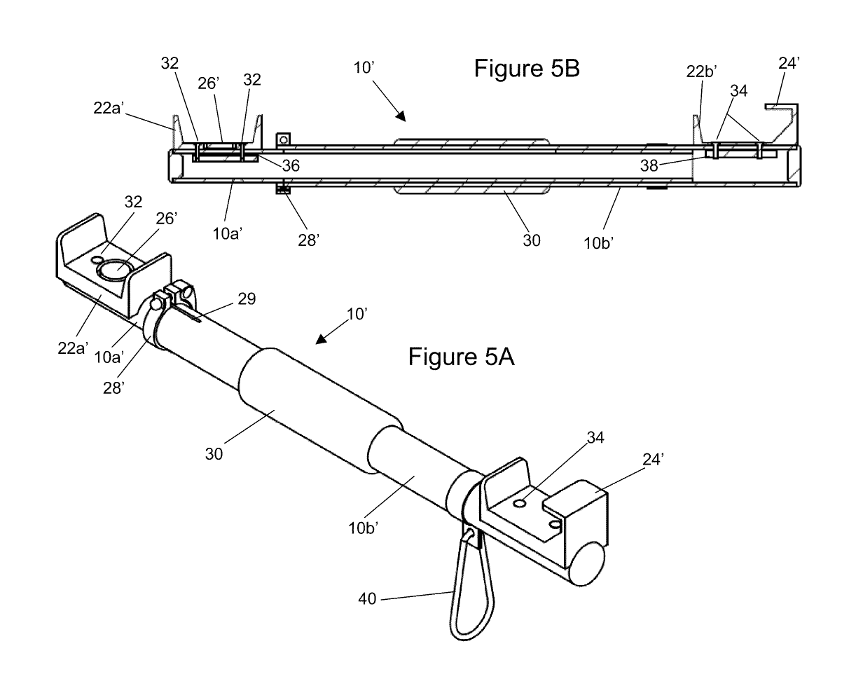

Also, for example, a plastics molding (FIG. 5) can be provided around the arm section 10b to facilitate easier gripping of the jig by a user.

Referring now to FIGS. 5A and 5B, there is shown a second embodiment of a jig 10′ according to the present invention, where similar reference numerals are used to describe like elements of the first embodiment. In this embodiment, the sections 10a′ and 10b′ are circular in section, with section 10a′ sliding within section 10b′. A plastics grip 30 is fitted over the section 10b' to facilitate easier handling of the device. Similarly, a carabiner holder 40 FIG. 5A) is provided along the length of the arm to facilitate transport and stowage of the device. Although not shown in FIGS. 5A and 5B each of the sections 10a′, 10b' can be keyed to ensure that when fitted together, they maintain alignment with one another to ensure the receptacles 22a′ and 22b′ face the same direction.

The end of section 10b′ overlapping section 10a′ is slotted 29 longitudinally and a tube clamp 28′ is fitted over this portion of the section 10b' so that opening and closing the tube clamp lever (only partially shown in FIG. 5A) quickly locks and releases the sections 10a′,10b′.

Finally, in the second embodiment, each of the receptacles 22a′ and 22b′ with their respective magnet 26′ and flange 24′ are fixed via bolts 32, 34 to internal block supports 36,38 located inside the sections 10a′,10b′. As well as facilitating initial assembly, this allows the receptacles to be interchanged with other receptacles to allow the jig to operate with other types of furring rails or in other applications. For example, a receptacle such as 22a′ including a magnet 26′ could be fixed to each end of the arm 10′ for spacing apart furring rails to be fixed to a wall.

The invention is not limited to the embodiment described herein which may be modified or varied without departing from the scope of the invention.

1. A jig for use in positioning steel furring rails in a suspended ceiling construction, the jig comprising an arm having at each end a receptacle for receiving a respective furring rail transversely of the arm, a first of the receptacles having an inwardly extending member on its outer edge for supporting the weight of that end of the jig by hooking the member around the edge of a furring rail proximate the first receptacle, and the second receptacle having a magnet for supporting the weight of that end of the jig by magnetic attraction to a furring rail in the second receptacle.

2. A jig according to claim 1 wherein the arm is adjustable in length.

3. A jig according to claim 2 wherein the arm is telescopically adjustable.

4. A jig according to claim 1 wherein said arm comprises a pair of tubular sections slidable relative to one another.

5. A jig according to claim 4 wherein said sections have one of: circular or rectangular profiles.

6. A jig according to claim 1 wherein one or both of said receptacles is removeably fixed to said arm.

7. A jig according to claim 4, further comprising a locking member for releaseably fixing the sections relative to one another.

8. A jig according to claim 7 wherein said locking member comprises one of: a clamp or a thumbscrew.

9. A jig according to claim 1 further comprising a grip located on said arm.

10. A jig according to claim 1 further comprising a holder enabling said jig to be carried.

11. A jig for use in positioning steel furring rails during building construction, the jig comprising an arm having at each end a receptacle for receiving a respective furring rail transversely of the arm, a first of the receptacles having a magnet for supporting that end of the jig by magnetic attraction to a furring rail in the first receptacle, and the second receptacle having a magnet for supporting that end of the jig by magnetic attraction to a furring rail in the second receptacle.

12. A jig according to claim 11 wherein the arm is adjustable in length.

13. A jig according to claim 11 wherein said arm comprises a pair of tubular sections slidable relative to one another.

14. A jig according to claim 11 wherein one or both of said receptacles is removeably fixed to said arm.

15. A jig according to claim 13, further comprising a locking member for releaseably fixing the sections relative to one another.

16. A jig according to claim 15 wherein said locking member comprises one of: a clamp or a thumbscrew.

17. A jig according to claim 11 further comprising a grip located on said arm.
